(19) United States
(12) Patent Application Publication
(10) Pub. No.: US 2024/0326738 A1
(43) Pub. Date: Oct. 3, 2024

(54) CONTROL SYSTEM FOR A MOTOR VEHICLE DOOR ARRANGEMENT

(71) Applicant: BROSE FAHRZEUGTEILE SE & CO. KOMMANDIT- GESELLSCHAFT, BAMBERG, Bamberg (DE)

(72) Inventors: Bertram Bopp, Bamberg (DE); Thomas Liedtke, Eisenach (DE); Bernd Herthan, Michelau (DE)

(21) Appl. No.: 18/277,725

(22) PCT Filed: Feb. 15, 2022
(86) PCT No.: PCT/EP2022/053582

§ 371 Date: Mar. 18, 2024

(30) Foreign Application Priority Data
Feb. 18, 2021 (DE) 10 2021 103 904.5

(51) Int. Cl. B60R 25/20; B60R 25/30; E05F 15/73; E05F 15/75

(52) U.S. Cl. CPC B60R 25/2045; B60R 25/305; E05F 15/75; E05F 2015/765

(57) ABSTRACT

A control system for a door, comprising an optical sensor, an optical display and a control. The control monitors image data detected by the optical sensor in a detection routine to determine the presence of an action, and, if the action is detected, triggers an opening process and/or closing process of a door. In the detection routine, the optical display affects the display of an operating element relating to the action. The control system comprises a waveguide having a first coupling portion and a second coupling portion. The optical sensor detects the image data based on light coupled into the waveguide via the first coupling portion and coupled out of the waveguide via the second coupling portion; and/or the optical display effects the display on the basis of light coupled into the waveguide via the second coupling portion and coupled out of the waveguide via the first coupling portion.

### CROSS-REFERENCE TO RELATED APPLICATIONS

This application is a national stage application under 35 U.S.C. 371 of International Patent Application Serial No. PCT/EP2022/053582, entitled “Control system for a Motor Vehicle Door Arrangement,” filed Feb. 15, 2022, which claims priority from German Patent Application No. DE 10 2021 103 904.5, filed Feb. 18, 2021, the disclosure of which is incorporated herein by reference.

### FIELD OF THE TECHNOLOGY

Embodiments relate to a control system for a motor-vehicle door arrangement, to a motor-vehicle door arrangement with such a control system, and also to a method for operating a motor-vehicle door arrangement.

### SUMMARY

The motor-vehicle door arrangements in question are arrangements for motor-vehicle doors such as side doors, rear doors, liftgates or tailgates, rear opening hoods, engine hoods or the like. The motor-vehicle door may in principle be articulated pivotably and/or longitudinally displaceably on the body of the motor vehicle.

The control system of the motor-vehicle door arrangement has an optical sensor arrangement, which serves for detecting an operator action. The operator action is in particular a specified operator gesture by which an opening process or a closing process of the motor-vehicle door is triggered, for example a motorized adjustment of the motor-vehicle door.

The detection of the operator action, which is performed here on the basis of image data, makes it possible to dispense with at least some of the mechanical operating elements that are otherwise provided on motor-vehicle doors, such as handles or switches. One challenge here is that reliable triggering of the operating process or closing process may be difficult for the inexperienced operator, in particular when using a contactless operator action. In particular in the case of motor-vehicle doors without handles, compliance with the specified operator gesture may mean that both the intended position and the sequence of movements of the operator gesture must be clear to the operator without further points of reference being provided by the appearance of the motor-vehicle door.

To improve operating convenience, an optical display arrangement is provided, producing a display of an operating element relating to the specified operator action. It is conceivable for example to attach to the body of the motor vehicle a screen which shows a virtual operating element, for instance the representation of a door handle. However, particularly in the case of contactless operator actions, such an optical display is still in need of improvement, since an operator action that has to be performed to a certain extent in free space must be clearly indicated to the operator. Also, the possibilities of a display by way of a screen are already restricted because of its space requirement on the body.

Various embodiments address the problem of providing a control system for a motor-vehicle door arrangement that further improves operating convenience when detecting the operator action.

The above problem is solved in the case of a method according to various embodiments described herein.

An aspect, for some embodiments, is the fundamental idea that transparent surfaces such as the window of the motor-vehicle door can also be used in order to achieve an improved display of the virtual operating element. In a dual use, the optical sensor arrangement may also operate by way of such surfaces.

Specifically, it is proposed that the control system can include a waveguide with a first coupling portion and a second coupling portion.

It is also proposed that the optical sensor arrangement captures the image data on the basis of light coupled into the waveguide by way of the first coupling portion and coupled out of the waveguide by way of the second coupling portion, and/or that the optical display arrangement produces the display on the basis of light coupled into the waveguide by way of the second coupling portion and coupled out of the waveguide by way of the first coupling portion.

The waveguide consequently allows light emitted by the display arrangement to be brought onto a (partially) transparent surface and/or this surface to be used for directing light from the surroundings of the motor-vehicle door to the sensor arrangement. In a way comparable to methods for image generation in the case of portable display devices of augmented reality, it is consequently possible for example for the window of the motor-vehicle door to retain the usual, transparent appearance but, when required, to be used as a display surface and/or detection surface. The sensor arrangement and display arrangement may in this case also be covered, and consequently arranged such that they are not visible to the operator.

In various embodiments, a holographic optical element is provided at least one of the coupling portions. In various embodiments, the display of the operating element hereby takes place as a hologram, for example as a volume hologram, so that the operator can also be provided with a spatial impression of the operating element and other items of information.

In various embodiments, the detection routine is based on the completion of a successful authentication check on the user. Apart from preventing unauthorized access to the vehicle, this provides the possibility of outputting personalized operator information, such as a welcoming scenario predetermined for the respective operator.

According to various embodiments, the authentication check may be triggered in response to sensing an approach by the operator and also include a biometric analysis of the operator. Apart from the use of proximity sensors such as ultrasonic sensors or radar sensors, which are for example also used in a dual use for obstacle detection in the motorized adjustment of the motor-vehicle door, the optical sensor arrangement may also be used for authentication.

For particularly intuitive operation, the control arrangement according to some embodiments may respond to the operator action by outputting acknowledgement information, which also serves for providing a visual depiction of the area of movement passed over by the motor-vehicle door to increase safety.

Furthermore, in response to detection of the operator action, an obstacle detection may take place, the result of which is in turn displayed. Apart from the output of feedback for the operator, consequently a warning is also generated for other road users, for instance pedestrians or cyclists, approaching the motor-vehicle door, to alert them to the opening process or closing process of the motor-vehicle door.

It is also possible for the display to be output with an adjustable wavelength according to various embodiments, whereby variously displayed items of information are clearly indicated by their coloring. It can be that the display transmitted by way of the coupling portions can also be influenced by different wavelengths by way of optical filters. In various embodiments, the optical filters are assigned respective holographic optical elements, so that various holograms can be selectively retrieved by selecting the wavelength, for example in order to show sequences of movements holographically.

Also of particular interest is the design according to some embodiments, the first coupling portion having multiple coupling regions, which are assigned to a respective field of view. In particular with holographic optical elements, it is possible to exploit the fact that a display from the coupling region is only visible from a specific viewing direction. For example, the operating element is only visible in a field of view in front of the motor-vehicle door, whereas the output of a warning indication is produced in a field of view in which road users passing by may be found.

In various embodiments, a motor-vehicle door arrangement having a motor-vehicle door and having the control system as proposed is provided in itself. The waveguide of the control system can be at least partially integrated in a window of the motor-vehicle door. Reference is made to the statements made in relation to the control system as proposed.

In various embodiments, a method for operating a motor-vehicle door arrangement with a control system is provided as such. Also in this respect, reference is made to the statements made in relation to the control system as proposed and in relation to the motor-vehicle door arrangement as proposed.

Various embodiments provide a control system for a motor-vehicle door arrangement, the control system having an optical sensor arrangement, an optical display arrangement and a control arrangement, the control arrangement monitoring image data captured by the optical sensor arrangement in a detection routine to ascertain the presence of a specified operator action and, in response to detection of the operator action, triggering an opening process and/or closing process of a motor-vehicle door of the motor-vehicle door arrangement, the optical display arrangement producing a display of an operating element relating to the specified operator action in the detection routine, wherein the control system has a waveguide with a first coupling portion and a second coupling portion, in that the optical sensor arrangement captures the image data on the basis of light coupled into the waveguide by way of the first coupling portion and coupled out of the waveguide by way of the second coupling portion, and/or in that the optical display device produces the display on the basis of light coupled into the waveguide by way of the second coupling portion and coupled out of the waveguide by way of the first coupling portion.

In various embodiments, the first and/or the second coupling portion has or have at least one holographic optical element.

In various embodiments, the control arrangement triggers the detection routine in response to completion of a successful authentication check on the operator. In various embodiments, the optical display arrangement produces a display of operator information, in particular personalized for the authenticated operator, when the detection routine is triggered.

In various embodiments, the control arrangement triggers the authentication check in response to sensing that the motor-vehicle door arrangement is being approached by the operator, such as by means of a proximity sensor and/or by means of the optical sensor arrangement, and/or in that the authentication check is based on a biometric analysis of the operator, in particular on the basis of the image data, and/or is based on the detection of an electronic key.

In various embodiments, the specified operator action includes the operator encroaching into a specified triggering area and/or the completion of a specified operator gesture, in particular involving movement. In various embodiments, the display of the operating element provides a visual depiction of the triggering area, the specified operator gesture and/or a closed state of the motor-vehicle door arrangement.

In various embodiments, the control arrangement outputs acknowledgement information, such as by means of the optical display arrangement, in response to detection of the operator action, in particular in that the acknowledgement information provides a visual depiction of a movement area passed over by the motor-vehicle door with the opening process and/or closing process.

In various embodiments, in response to detection of the operator action, the control arrangement performs an obstacle detection routine, in which a possible collision of the motor-vehicle door in the opening process and/or closing process with an object that is in the movement area and/or is approaching the movement area is determined. In various embodiments, the control arrangement outputs the result of the obstacle detection routine, in particular with the acknowledgement information, by means of the optical display arrangement.

In various embodiments, the optical display arrangement is set up for outputting the display with an adjustable wavelength range, and in that the first and/or the second coupling portion has or have at least one optical filter, so that the display is adjustable in dependence on the wavelength range of the light by way of the first and/or the second coupling portion. In various embodiments, an optical filter is respectively assigned a holographic optical element.

In various embodiments, the first coupling portion has multiple coupling regions, which have the effect of producing selective coupling in of light into a field of view assigned to the coupling region and/or selective coupling out of light from a field of view assigned to the coupling region. In various embodiments, one of the fields of view is provided for the display of the operating element and in that one of the fields of view is provided for the output of a warning indication in response to triggering of the opening process and/or closing process.

Various embodiments provide a motor-vehicle door arrangement having a motor-vehicle door and a control system as described herein, wherein the waveguide of the control system is at least partially integrated in a window of the motor-vehicle door.

In various embodiments, the first coupling portion is set up for coupling in light from an inner side and/or outer side assigned to the motor-vehicle door arrangement and/or for coupling out light into an inner side and/or outer side assigned to the motor-vehicle door arrangement.

In various embodiments, the motor-vehicle door arrangement has an electrical drive arrangement for the motorized adjustment of the motor-vehicle door, in that the control arrangement activates the drive arrangement for performing the opening process and/or the closing process in response to detection of the operator action.

In various embodiments, unlocking of a motor-vehicle lock assigned to the motor-vehicle door, motorized adjustment of the motor-vehicle door into a partly opened position, motorized adjustment of the motor-vehicle door into an open position and/or motorized assistance for an actuating force introduced manually into the motor-vehicle door is provided as an opening process, and/or in that locking of a motor-vehicle door lock assigned to the motor-vehicle door, motorized adjustment of the motor-vehicle door into a closed position and/or motorized assistance for an actuating force introduced manually into the motor-vehicle door is provided as a closing process. In various embodiments, the motor-vehicle door is designed without any handle on the assigned inner side and/or outer side.

Various embodiments provide a method for operating a motor-vehicle door arrangement with a control system having an optical sensor arrangement, an optical display arrangement and a control arrangement, image data captured by the optical sensor arrangement being monitored by means of the control arrangement in a detection routine to ascertain the presence of a specified operator action and, in response to detection of the operator action, an opening process and/or closing process of a motor-vehicle door of the motor-vehicle door arrangement being triggered, a display of an operating element relating to the specified operator action being produced by means of the optical display arrangement in the detection routine, wherein the control system has a waveguide with a first coupling portion and a second coupling portion, in that, by means of the optical sensor arrangement, the image data are captured on the basis of light coupled into the waveguide by way of the first coupling portion and coupled out of the waveguide by way of the second coupling portion, and/or that, by means of the optical display arrangement, the display is produced on the basis of light coupled into the waveguide by way of the second coupling portion and coupled out of the waveguide by way of the first coupling portion.

### BRIEF DESCRIPTION OF THE DRAWINGS

Various aspects are explained more specifically below on the basis of a drawing, which merely represents an exemplary embodiment and in which:

FIG. 1 shows a schematic representation of a motor vehicle with the control system as proposed and the motor-vehicle door arrangement as proposed, and

FIG. 2 shows a schematic sectional representation of the control system as proposed.

### DETAILED DESCRIPTION

Various embodiments relate to a control system 1 for a motor-vehicle door arrangement 2. The control system 1 has an optical sensor arrangement 3, which is designed, in various embodiments, as a camera, which captures image data. Furthermore, the control system 1 has optical display arrangement 4.

A control arrangement 5 is connected in terms of control to the optical sensor arrangement 3 and the optical display arrangement 4 and is set up for performing a detection routine. The control arrangement 5 monitors the image data captured by the optical sensor arrangement 3 in a detection routine to ascertain the presence of a specified operator action. Here, a detection criterion for the image data, which for example represents a predetermined operator gesture such as a specific hand movement at the motor-vehicle door arrangement 2, is stored in the control arrangement 5. When the detection criterion is satisfied, the specified operator action is considered to be detected.

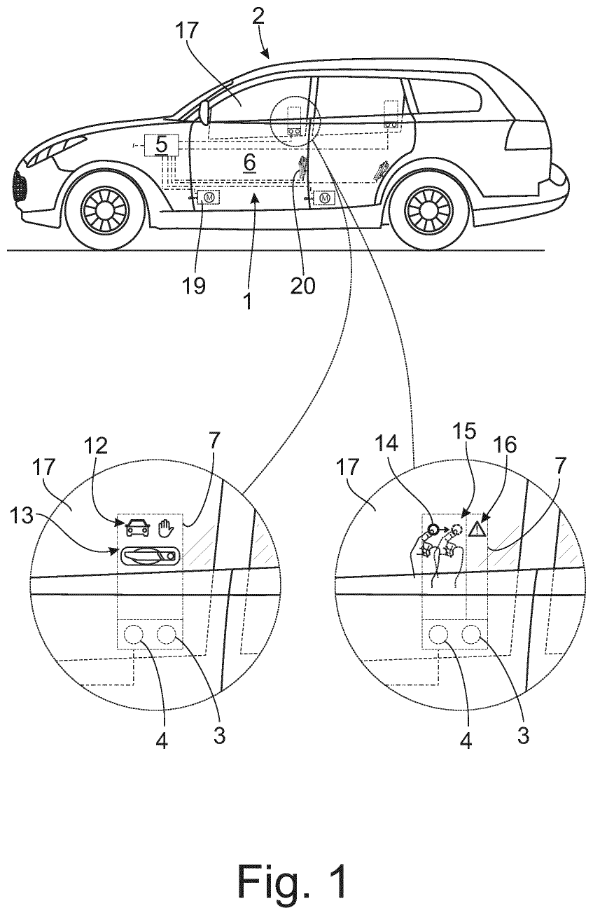

In response to detection of the operator action, the control arrangement 5 in turn triggers an opening process and/or closing process of a motor-vehicle door 6 of the motor-vehicle door arrangement 2. Various designs are conceivable for the motor-vehicle door 6, reference being made to the explanations given in the introductory part of the description. In FIG. 1, by way of example, the control arrangement 5 is also represented as a central controller for multiple motor-vehicle doors 6. The control arrangement 5 may likewise be a door control device which is assigned to a single motor-vehicle door 6 and in particular is integrated in the motor-vehicle door 6. By way of example, the following speaks about a single motor-vehicle door 6.

An opening process is understood here as meaning at least one action of transferring the motor-vehicle door 6 from a closed position into an open position. A closing process is correspondingly understood as meaning at least one action of transferring the motor-vehicle door 6 from an open position into the closed position. This is consequently not necessarily a completely automatic adjustment of the motor-vehicle door 6. As the following also makes clear, the transfer of the motor-vehicle door 6 between the stated positions may also additionally require manual intervention.

Here, the optical display arrangement 3 is activated by the control arrangement 5 in the detection routine to produce a display of an operating element relating to the specified operator action. The display may generally be, inter alia, a form of assistance for showing in which position, and possibly with which sequence of movements, the operator action has to take place.

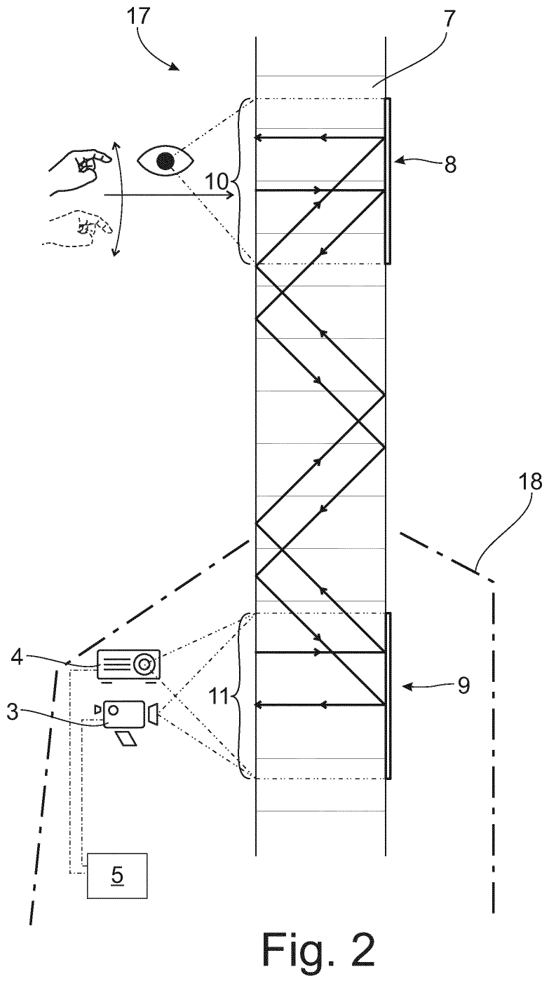

It is thus essential that the control system 1 has a waveguide 7, which is shown more specifically in FIG. 2. For coupling light out and in, here the waveguide 7 is equipped with a first optical coupling element 8 and a second optical coupling element 9. The waveguide 7 has a first coupling portion 10 and a second coupling portion 11. The waveguide 7 is set up to pass on light by way of reflections substantially along a preferential direction of the waveguide 7. In various embodiments, the reflection is based on total reflection at the surface of the waveguide 7 and/or on a reflective coating of the waveguide 7. The optical coupling elements 8, 9 are set up for coupling the light in and out at the coupling portions 10, 11 of the waveguide 7. The coupling portions 10, 11 are optically connected to one another by way of the waveguide 7.

It is also essential that the optical sensor arrangement 3 captures the image data on the basis of light coupled into the waveguide by way of the first coupling portion 10 and coupled out of the waveguide 7 by way of the second coupling portion 11, and/or that the optical display arrangement 4 produces the display on the basis of light coupled into the waveguide 7 by way of the second coupling portion 10 and coupled out of the waveguide 7 by way of the first coupling portion 11.

Here, the coupling portions 10, 11 may each have multiple optical coupling elements 8, 9, with for example respective coupling elements 8, 9 being assigned to the optical sensor arrangement 3 and respective coupling elements 8, 9 being assigned to the optical display arrangement 4. Coupling elements 8, 9 both of the optical sensor arrangement 3 and of the optical display arrangement 4 may also be used.

In various embodiments, the sensor arrangement 3 and the display arrangement 4 are arranged on the second coupling portion 11, which is assigned to the second coupling element 9. It is made possible here by the design of the waveguide 7 that the sensor arrangement 3 captures the image data for the surroundings of the motor-vehicle door arrangement 2. In the design that is shown, the design of the waveguide 7 also makes it possible for the operating element to be displayed on the first coupling portion 10.

The optical coupling elements 8, 9 may be based here on various principles known per se, for example on partly transparent surfaces in the waveguide 7, structuring of the surface of the waveguide 7 as diffractive optical elements or the like. According to various embodiments, the first and/or the second coupling portion 10, 11 has or have at least one holographic optical element. The holographic optical element can be used here to implement at least partial display of the operating element as a hologram. The holographic optical element can be a film that is exposed to light by holographic methods and is integrated in the waveguide 7 and/or applied to it.

In various embodiments, the control arrangement 5 triggers the detection routine in response to completion of a successful authentication check on the operator. The optical display arrangement 3 may be used to produce a display of operator information 12 when the detection routine is triggered.

For example, as shown in FIG. 1, a welcoming scenario is initiated and items of information on the state of the motor-vehicle are displayed to the operator (without holographic representation) as operator information 12. Here, the display of the operating element provided as a virtual door handle 13 and relating to the specified operator action also takes place as a hologram. The display may in particular be personalized for the authenticated operator, with personalized display settings for each operator being stored in the control arrangement 5.

The control arrangement 5 may trigger the authentication check in response to sensing that the motor-vehicle door arrangement is being approached by the operator. The approach by the operator may be sensed by means of a proximity sensor that is not shown. The proximity sensor may for example be based on position sensing by way of ultrawideband (UWB), radar waves, ultrasound, capacitance measurements or the like. It is likewise conceivable that an approach by the operator is sensed by means of the optical sensor arrangement 3 of the control system 1 by way of image recognition on the basis of the image data.

The authentication check may be based on a biometric analysis of the operator, in particular on the basis of the image data captured by means of the sensor arrangement 3. For example, facial recognition is performed on the basis of the image data. It is likewise provided according to various embodiments that the authentication check is based on the detection of an electronic key. This may involve an electronic key being wirelessly transmitted from a mobile device of the operator and received and verified by the control arrangement 5 or a receiver assigned to the control arrangement 5.

According to various embodiments, the specified operator action includes the operator encroaching into a specified triggering area. The triggering area can be specified as a three-dimensional space, the control arrangement 5 checking on the basis of the image data whether the operator encroaches into the triggering area at least with part of its body. For example, it is provided that the hand of the operator approaches a specified portion of the motor-vehicle door arrangement, such as a portion assigned to the displayed operating element, to within a specified minimum distance.

In various embodiments, the specified operator action includes the completion of a specified operator gesture, in particular involving movement. With the detection of the operator action, consequently not only the position of the operator is evaluated, but for example also the body posture adopted by the operator. For example, holding up the outstretched hand in a specified triggering area is provided as an operator gesture, the hand being detected by way of image recognition. With an operator gesture involving movement, the variation over time of the position of the operator is also included. A wiping movement of the operator's hand may for example be provided as an operator gesture.

In various embodiments, the display of the operating element provides a visual depiction of the triggering area, the specified operator gesture and/or a closed state of the motor-vehicle door arrangement. The triggering area can be given a spatial impression by way of holographic optical elements. An operator gesture involving movement can similarly be visually depicted on the display by way of a moving symbol 14, as also shown in FIG. 1. Here it is conceivable that the moving symbol 14 is used to show the operator gesture by way of demonstration before it is performed by the operator and/or to provide a visual depiction of the operator gesture while it is being performed, for instance by the symbol 14 following the movement of the hand. Possible closed states of the motor-vehicle door arrangement 2 to be displayed are, inter alia, an antitheft, locked, unlocked and/or childproof closed state.

According to various embodiments, the control arrangement 5 outputs acknowledgement information, such as by means of the optical display arrangement 4, in response to detection of the operator action. Successful detection of the operator gesture is hereby clearly indicated to the operator. The acknowledgement information may also include providing a visual depiction of an area of movement passed over by the motor-vehicle door 6 with the opening process and/or closing process in response to the detection of the operator action. For providing a visual depiction of the movement area, for example the ground in front of the motor-vehicle door arrangement 6 is illuminated by way of lines, colored regions or the like, an additional display arrangement can be provided for this.

According to a further design, in response to detection of the operator action, the control arrangement 5 performs an obstacle detection routine, in which a possible collision of the motor-vehicle door 6 in the opening process and/or closing process with an object that is in the movement area and/or is approaching the movement area is determined. Depending on the result of the obstacle detection routine, the performance of the opening process and/or closing process may be interrupted or altered if a possible collision is detected. In the obstacle detection routine, the image data captured by the sensor arrangement 3 are also used in particular, it also being possible for example to use further sensors, which sense objects in the vicinity of the motor-vehicle door arrangement 2 on the basis of radar waves, ultrasound, capacitance measurements or the like.

The control arrangement 5 can output the result of the obstacle detection routine, in particular with the acknowledgement information, by means of the optical display arrangement 3. For example, with the acknowledgement information, the operator is displayed a successful detection of the operator gesture, but is also notified that the opening process and/or closing process is interrupted because of a possible collision.

The optical display arrangement 3 can be set up for outputting the display with an adjustable wavelength range of the light, for example by way of RGB-LEDs or the like. A wavelength range may be understood here as also meaning a specific wavelength in the case of monochromatic light. In particular, however, a distribution of various wavelengths in an adjustable wavelength range is emitted. The first and/or the second coupling portion 8, 9 may have at least one optical filter, so that the display is adjustable in dependence on the wavelength of the light by way of the first and/or the second coupling portion 10, 11. The optical filters may be assigned respective optical elements in the coupling portions 10, 11, which implement a coupling in and/or coupling out of the light in different ways. Accordingly, the coupling in and/or coupling out of the light is selected by way of the wavelength of the from the optical display arrangement 3.

In various embodiments, an optical filter is respectively assigned a holographic optical element. Depending on the provided wavelength of the light, the display can consequently a specific hologram be retrieved by way of one of the holographic optical elements. Apart from the possibility of making the display of the operating element, the operator information and/or the acknowledgement information colored, different holograms can consequently be used for the respective display. It is also possible to display a “moving” hologram in the form of a time sequence of different holograms.

According to various embodiments, shown in FIG. 1, the first coupling portion 10 has multiple coupling regions 15, 16, which have the effect of producing selective coupling in of light into a field of view assigned to the coupling region 15, 16 and/or selective coupling out of light from a field of view assigned to the coupling region 15, 16. In particular with holographic optical elements, there is the possibility of specifying the field of view, the hologram only being visible within a specific range of viewing angles. It can be the case here that one of the fields of view is provided for the display of the operating element, which in FIG. 1 is implemented by the coupling region 15. This field of view is set in such a way that the symbol 14 is only visible to an operator standing in front of the motor-vehicle door 6. A further field of view, here the field of view assigned to the coupling region 16, is provided for the output of a warning indication in response to triggering of the opening process and/or closing process and for example is only visible from a viewing direction from the rear of the motor vehicle.

According to various embodiments, the aforementioned motor-vehicle door arrangement 2, having a motor-vehicle door 6 and a control system 1 as proposed, is provided in itself. Here, the waveguide 7 of the control system 1 is at least partially integrated in a window 17 of the motor-vehicle door 6. Reference is made to all other statements made in relation to the control system 1 as proposed.

As made clear by FIG. 2, in various embodiments, the first coupling portion 10 is at least partially arranged on an exposed portion of the window 17. The second coupling portion 11, the optical sensor arrangement 3 and the optical output arrangement 4 are arranged on a portion of the window 17 that is covered by a covering 18.

According to various designs, the first coupling portion 10 is set up for coupling in light from an inner side and/or outer side assigned to the motor-vehicle door arrangement 2 and/or for coupling out light into an inner side and/or outer side assigned to the motor-vehicle door arrangement 2. The assigned inner side is in this case intended for facing the interior space of the motor vehicle in the fitted state of the motor-vehicle door arrangement 2. Correspondingly, the outer side is facing the surroundings of the motor vehicle in the fitted state. Consequently, depending on the orientation, the control system 1 can serve for display and operation from the inside and/or outside.

In various embodiments, the motor-vehicle door arrangement 2 has an electrical drive arrangement 19 for the motorized adjustment of the motor-vehicle door 6. In various embodiments, the control arrangement 5 activates the drive arrangement 19 for performing the opening process and/or the closing process in response to detection of the operator action, in particular subject to the result of an obstacle detection routine.

Apart from a motorized adjustment, unlocking of a motor-vehicle lock 20 assigned to the motor-vehicle door 6 may also be provided as an opening process. A motorized adjustment of the motor-vehicle door 6 may in principle take place into a partly opened position, in which a gap is formed between a doorframe and the motor-vehicle door 6, the gap making it possible in particular for the operator to grip the motor-vehicle door 6 to open it further. A motorized adjustment of the motor-vehicle door 6 may likewise take place into an open position, the motor-vehicle door being opened, in particular completely, without further intervention by the operator. Also conceivable is motorized assistance for an actuating force introduced manually into the motor-vehicle door, the motor-vehicle door 6 executing a joint manual and motorized adjustment movement.

The drive arrangement 19 serves here in particular for motorized assistance for the operator to reduce the manual forces.

Correspondingly, locking of a motor-vehicle door lock 20 assigned to the motor-vehicle door 6, motorized adjustment of the motor-vehicle door 6 into a closed position and/or motorized assistance for an actuating force introduced manually into the motor-vehicle door 6 may be provided as a closing process.

It can be here that the motor-vehicle door 6 is designed without any handle on the assigned inner side and/or outer side. In particular, the aforementioned adjustment into a partly opened position is used to enable the operator to move the motor-vehicle door 6 by way of the gap.

According to various embodiments, a method for operating a motor-vehicle door arrangement 2 is provided as such. A control system 1 having an optical sensor arrangement 3, an optical display arrangement 4 and a control arrangement 5 is provided, image data captured by the optical sensor arrangement 3 being monitored by means of the control arrangement 5 in a detection routine to ascertain the presence of a specified operator action and, in response to detection of the operator action, an opening process and/or closing process of a motor-vehicle door 6 of the motor-vehicle door arrangement 2 being triggered, a display of an operating element relating to the specified operator action being produced by means of the optical display arrangement 4 in the detection routine.

It is essential here that the control system 1 has a waveguide 7 with a first coupling portion 10 and a second coupling portion 11.

It is also essential that, by means of the optical sensor arrangement 3, the image data are captured on the basis of light coupled into the waveguide 7 by way of the first coupling portion 10 and coupled out of the waveguide 7 by way of the second coupling portion 11, and/or that, by means of the optical display arrangement 4, the display is produced on the basis of light coupled into the waveguide 7 by way of the second coupling portion 10 and coupled out of the waveguide 7 by way of the first coupling portion 11. Reference is made to the statements made in relation to the control system 1 as proposed and in relation to the motor-vehicle door arrangement 2 as proposed.

1. A control system for a motor-vehicle door arrangement, the control system comprising an optical sensor arrangement, an optical display arrangement and a control arrangement, the control arrangement monitoring image data captured by the optical sensor arrangement in a detection routine to ascertain the presence of a specified operator action and, in response to detection of the operator action, triggering an opening process and/or closing process of a motor-vehicle door of the motor-vehicle door arrangement, the optical display arrangement producing a display of an operating element relating to the specified operator action in the detection routine,
wherein the control system has a waveguide with a first coupling portion and a second coupling portion, in that the optical sensor arrangement captures the image data on the basis of light coupled into the waveguide by way of the first coupling portion and coupled out of the waveguide by way of the second coupling portion and/or in that the optical display device produces the display on the basis of light coupled into the waveguide by way of the second coupling portion and coupled out of the waveguide by way of the first coupling portion.

2. The control system as claimed in claim 1, wherein the first and/or the second coupling portion has or have at least one holographic optical element.

3. The control system as claimed in claim 1, wherein the control arrangement triggers the detection routine in response to completion of a successful authentication check on the operator.

4. The control system as claimed in claim 3, wherein the control arrangement triggers the authentication check in response to sensing that the motor-vehicle door arrangement is being approached by the operator.

5. The control system as claimed in claim 1, wherein the specified operator action includes the operator encroaching into a specified triggering area and/or the completion of a specified operator gesture.

6. The control system as claimed in claim 1, wherein the control arrangement outputs acknowledgement information in response to detection of the operator action.

7. The control system as claimed in claim 1, wherein, in response to detection of the operator action, the control arrangement performs an obstacle detection routine, in which a possible collision of the motor-vehicle door in the opening process and/or closing process with an object that is in the movement area and/or is approaching the movement area is determined.

8. The control system as claimed in claim 1, wherein the optical display arrangement is set up for outputting the display with an adjustable wavelength range, and wherein the first and/or the second coupling portion has or have at least one optical filter, so that the display is adjustable in dependence on the wavelength range of the light by way of the first and/or the second coupling portion.

9. The control system as claimed in claim 1, wherein the first coupling portion has multiple coupling regions, which have the effect of producing selective coupling in of light into a field of view assigned to the coupling region and/or selective coupling out of light from a field of view assigned to the coupling region.

10. A motor-vehicle door arrangement having a motor-vehicle door and a control system as claimed in claim 1, wherein the waveguide of the control system is at least partially integrated in a window of the motor-vehicle door.

11. The motor-vehicle door arrangement as claimed in claim 10, wherein the first coupling portion is set up for coupling in light from an inner side and/or outer side assigned to the motor-vehicle door arrangement and/or for coupling out light into an inner side and/or outer side assigned to the motor-vehicle door arrangement.

12. The motor-vehicle door arrangement as claimed in claim 10, wherein the motor-vehicle door arrangement has an electrical drive arrangement for the motorized adjustment of the motor-vehicle door, wherein the control arrangement activates the drive arrangement for performing the opening process and/or the closing process in response to detection of the operator action.

13. The motor-vehicle door arrangement as claimed in claim 10, wherein unlocking of a motor-vehicle lock assigned to the motor-vehicle door, motorized adjustment of the motor-vehicle door into a partly opened position, motorized adjustment of the motor-vehicle door into an open position and/or motorized assistance for an actuating force introduced manually into the motor-vehicle door is provided as an opening process, and/or wherein locking of a motor-vehicle door lock assigned to the motor-vehicle door, motorized adjustment of the motor-vehicle door into a closed position and/or motorized assistance for an actuating force introduced manually into the motor-vehicle door is provided as a closing process.

14. A method for operating a motor-vehicle door arrangement with a control system having an optical sensor arrangement, an optical display arrangement and a control arrangement, image data captured by the optical sensor arrangement being monitored by the control arrangement in a detection routine to ascertain the presence of a specified operator action and, in response to detection of the operator action, an opening process and/or closing process of a motor-vehicle door of the motor-vehicle door arrangement being triggered, a display of an operating element relating to the specified operator action being produced by the optical display arrangement in the detection routine,
wherein the control system has a waveguide with a first coupling portion and a second coupling portion, wherein, by the optical sensor arrangement, the image data are captured on the basis of light coupled into the waveguide by way of the first coupling portion and coupled out of the waveguide by way of the second coupling portion, and/or that, by means of the optical display arrangement, the display is produced on the basis of light coupled into the waveguide by way of the second coupling portion and coupled out of the waveguide by way of the first coupling portion.

15. The control system as claimed in claim 3, wherein the optical display arrangement produces a display of operator information when the detection routine is triggered.

16. The control system as claimed in claim 3, wherein the control arrangement triggers the authentication check in response to sensing that the motor-vehicle door arrangement is being approached by the operator by a proximity sensor and/or by the optical sensor arrangement, and/or wherein the authentication check is based on a biometric analysis of the operator and/or is based on the detection of an electronic key.

17. The control system as claimed in claim 1, wherein the specified operator action includes the operator encroaching into a specified triggering area and/or the completion of a specified operator gesture, wherein the display of the operating element provides a visual depiction of the triggering area, the specified operator gesture and/or a closed state of the motor-vehicle door arrangement.

18. The control system as claimed in claim 1, wherein the control arrangement outputs acknowledgement information by the optical display arrangement, in response to detection of the operator action.

19. The control system as claimed in claim 7, wherein the control arrangement outputs the result of the obstacle detection routine by the optical display arrangement.

20. The control system as claimed in claim 8, wherein an optical filter is respectively assigned a holographic optical element.
